(19) United States
(12) Patent Application Publication
(10) Pub. No.: US 2010/0068903 A1
(43) Pub. Date: Mar. 18, 2010

(54) Electrical connector

(76) Inventors: Shu-Man Chiang, Tu-Cheng City (TW); Hsin-Tsung Ho, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,328

(22) Filed: Sep. 16, 2008

(51) Int. Cl. H01R 12/00

(52) U.S. Cl. 439/79

(57) ABSTRACT

An electrical connector includes a housing, a plurality of terminals fixed in the housing and a shell encircling the housing. The shell has two opposing sidewalls each having a holding portion extending and bending outward therefrom and being spaced a distance from a bottom of the shell. An inserting portion extends downward from a place of the holding portion. The electrical connector is adapted for being mounted to a printed circuit board which defines a receiving space and two fixing holes with the inserting portions inserted into the fixing holes and the holding portions placed on the printed circuit board. Therefore, the electrical connector has a portion below the holding portions sunk in the receiving space and the total height thereof is reduced.

### BACKGROUND OF THE INVENTION

1. Field of the Invention

The present invention relates to an electrical connector, and more particularly to an electrical connector capable of being mounted on a printed circuit board and having a reduced height thereof.

2. The Related Art

A traditional electrical connector capable of being mounted on a printed circuit board includes a housing, a plurality of terminals received in the housing and a shell encircling the housing. The terminals have soldering portions extending out of the housing and being soldered to the printed circuit board by surface mounting technology (SMT). In order to further stabilize the electrical connector to the printed circuit board, in general, the shell of the electrical connector defines auxiliary welding portions soldered to the printed circuit board.

However, the above-mentioned manner that the electrical connector mounted to the printed circuit board makes the whole electrical connector located above the printed circuit board, which increases the total height thereof and is undesirable in the circumstance where the sizes of electronic devices are limited.

### SUMMARY OF THE INVENTION

An object of the present invention is to provide an electrical connector capable of being mounted on a printed circuit board and having a reduced height thereof The electrical connector includes a housing, a plurality of terminals fixed in the housing and a shell encircling the housing. The shell has two opposing sidewalls each having a holding portion extending and bending outward therefrom and being spaced a distance from a bottom of the shell. An inserting portion extends downward from a place of the holding portion. The printed circuit board defines a receiving space and two fixing holes. The electrical connector is mounted to the printed circuit board with the inserting portions inserted into the fixing holes and the holding portions placed on the printed circuit board. Therefore, the electrical connector has a portion below the holding portions sunk in the receiving space.

As described above, the electrical connector is connected to the printed circuit board in a sinking way to reduce the total height thereof, which makes the assembly thereof more adapted for applying to the electronic device which has small dimension.

### BRIEF DESCRIPTION OF THE DRAWINGS

The present invention will be apparent to those skilled in the art by reading the following description of an embodiment thereof, with reference to the attached drawings, in which:

FIG. 1 is an exploded view of an electrical connector in accordance with the present invention;

FIG. 2 is a perspective view of a shell of the electrical connector;

FIG. 3 is a perspective view of the electrical connector and a printed circuit board before the electrical connector is assembled to the printed circuit board; and

FIG. 4 is a perspective view of the electrical connector and the printed circuit board after the electrical connector is assembled to the printed circuit board.

### DETAILED DESCRIPTION OF THE PREFERRED EMBODIMENT

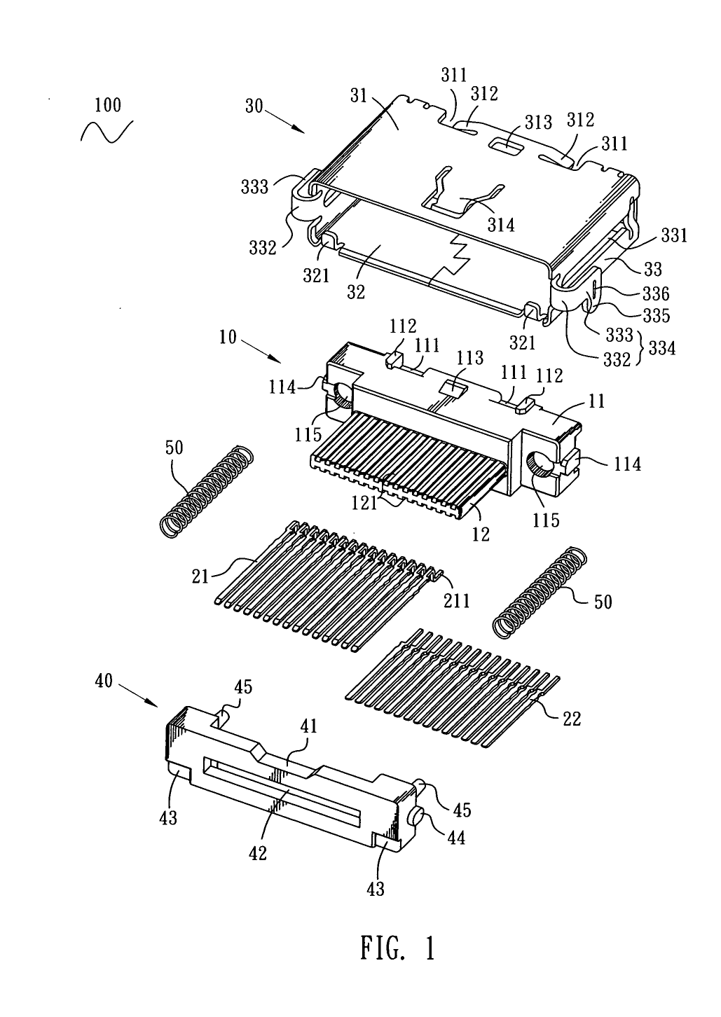

With reference to FIG. 1, an electrical connector 100 according to the invention includes a housing 10, a plurality of first and second terminals 21, 22, a shell 30, a dustproof cover 40 and a pair of springs 50.

The housing 10 has a base portion 11 and a mating portion 12 extending forward from a front surface of the base portion 11. The base portion 11 defines two recesses 111 at a rear end of a top surface thereof and two projections 112 respectively projecting upward along one edge of each recess 111. A wedge-shaped lump 113 projects upward from the top surface of the base portion 11 and is disposed between the two recesses 111. The base portion 11 defines two fixing lumps 114 protruding outward from two opposite sides thereof and two through holes 115 respectively adjacent to the two opposite sides of the base portion 11. The mating portion 12 defines two rows of terminal grooves 121 running front-to-rear and penetrating through the base portion 11.

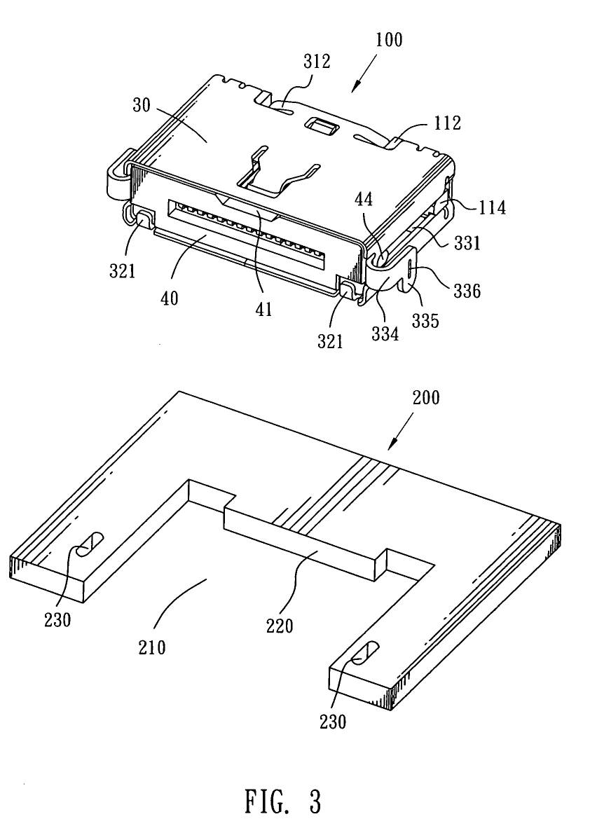

The first and second terminals 21, 22 are respectively fixed in an upper row of the terminal grooves 121 and a lower row of the terminal grooves 121 of the housing 10. Each of the first terminals 21 has a contacting portion 211 horizontally extending out of the terminal groove 121 for being soldered to a printed circuit board 200 (as shown in FIG. 3).

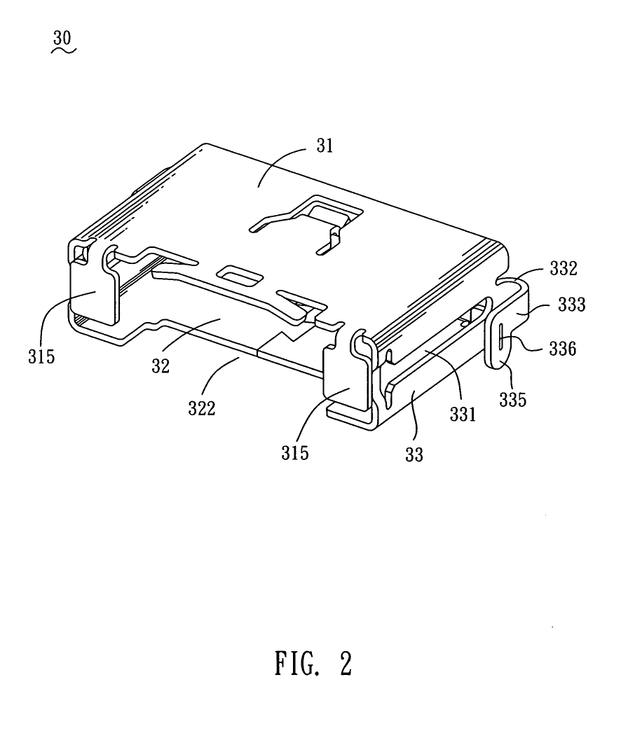

The shell 30 has a top wall 31, a bottom wall 32 and two sidewalls 33, which corporately define a receiving chamber (not labeled) for receiving the housing 10 therein. The top wall 31 defines two gaps 311 at a rear end thereof and two elastic pieces 312 extending and slanting at an angle along the gaps 311 and opposite each other. The top wall 31 defines a location hole 313 between the two gaps 311 and a cantilever 314 having a curved free end extending into the inside of the shell 30. As best shown in FIG. 2, the shell 30 defines a pair of stoppers 315 extending downward from the rear end of the top wall 31 and adjacent to the sidewalls 33. Bottoms of the stoppers 315 are near to the bottom wall 33.

The bottom wall 32 defines a pair of locking tabs 321 curling upward at a front end thereof and adjacent to the sidewalls 33 respectively. A rear end of the bottom wall 32 is cut off partly to form an opening 322 (as shown in FIG. 2).

Each of the sidewalls 33 defines a guiding slot 331 extending front to rear. A front end of each sidewall 33 is curled outward to form a bending portion 332. A free end of the bending portion 332 continuously extends rearward to form an extending portion 333 substantially parallel to the sidewall 33. The bending portion 332 and the extending portion 333 together form a substantially U-shaped holding portion 334 spaced a distance from the bottom wall 32. An inserting portion 335 extends downward from a free end of the extending portion 333. A projecting rib 336 is defined across the junction of the extending portion 333 and the inserting portion 335 for strengthening the structure of the extending portion 333 and the inserting portion 335.

The dustproof cover 40 is of substantially rectangular shape and defines a trough 41 at a top surface thereof. A through cavity 42 is defined transversely and penetrates through the dustproof cover 40. A bottom portion of a front surface of the dustproof cover 40 defines a pair of notches 43 respectively positioned at two corners thereof. The dustproof cover 40 further defines two sliding lumps 44 projecting from two sides thereof and two location rods 45 extending rearward from a rear surface thereof and apart from each other.

Please refer to FIGS. 1-3. In assembly, the housing 10 with the first and second terminals 21, 22 fixed therein is received in the shell 30. The projections 112 are located in the gaps 311. The elastic pieces 312 are received in the recesses 111. The wedge-shaped lump 113 is fixed in the location hole 313 and the fixing lumps 114 are jammed into the guiding slots 331 for fixing the housing 10 in the shell 30 firmly. One end of each spring 50 encloses the location rod 45 of the dustproof cover 40 and the other end thereof passes through the through hole 115 of the housing 10 and is against the stopper 315 of the shell 30. The locking tabs 321 are engaged with the notches 43. Thereby, the dustproof cover 40 is assembled in the shell 30 with the sliding lumps 44 buckled into the guiding slots 331.

When a complementary connector (not shown) is matched with the electrical connector 100, the complementary connector pushes the dustproof cover 40 rearward, then the springs 50 is compressed and the sliding lumps 44 move rearward along the guiding slots 311. Meanwhile, the terminals 21, 22 fixed in the terminal grooves 121 extend out of the through cavity 42 for electrically connecting with the complementary connector and the cantilever 314 passes through the trough 41 with the curved free end of the cantilever 314 pressing tightly against the complementary connector to fix the electrical connector 100 and the complementary connector. When the complementary connector is draw out of the electrical connector 100, the dustproof cover 40 can return to original position to perform anti-dust function because of the elastic potential energy of the springs 50.

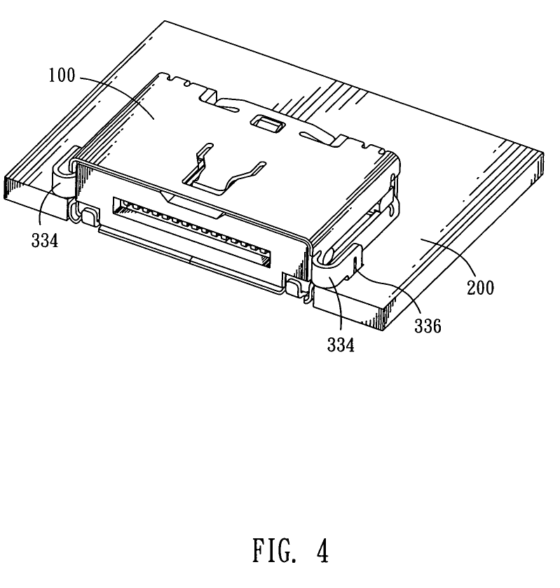

Refer to FIGS. 3 and 4, the electrical connector 100 is capable of being mounted on the printed circuit board 200. The printed circuit board 200 defines a receiving space 210 at one edge thereof and a protruding beam 220 projecting transversely from the receiving space 210. The printed circuit board 200 also defines two fixing holes 230 adjacent two opposite sides of the receiving space 210.

When the electrical connector 100 is mounted to the printed circuit board 200, the inserting portions 335 are inserted into the fixing holes 230 and the holding portions 334 are placed on the printed circuit board 200. The electrical connector 100 has a portion below the holding portions 334 received in the receiving space 210. Moreover, the protruding beam 220 extends into the opening 322 of the shell 30. Thereby, the electrical connector 100 is assembled to the printed circuit board 200 and the total height thereof is reduced.

As the above description, the electrical connector 100 is connected to the printed circuit board 200 in a sinking way that the inserting portions 335 are inserted into the fixing holes 230, the holding portions 334 are placed on the printed circuit board 200 and the electrical connector 100 has a portion below the holding portions 334 received in the receiving space 210, which reduces the height of the assembly of the electrical connector 100 and the printed circuit board 200, so that the assembly is more adapted for applying to the electronic device which has small dimension.

What is claimed is:

1. An electrical connector adapted for being positioned to a printed circuit board, comprising:
a housing;
a plurality of terminals fixed in the housing; and
a shell encircling the housing, the shell having two opposing sidewalls, at least one holding portion extending and bending outward from one of the sidewalls and being spaced a distance from a bottom of the shell for being placed on the printed circuit board, an inserting portion extending downward from the holding portion for being inserted into a fixing hole defined in the printed circuit board.

2. The electrical connector as claimed in claim 1, wherein the holding portion comprises a bending portion of substantial U-shape connected with the sidewall and an extending portion extending from a free end of the bending portion which is substantially parallel with the sidewall, the inserting portion extending downward from the extending portion.

3. The electrical connector as claimed in claim 2, wherein a projecting rib is defined across the junction of the extending portion and the inserting portion.

4. The electrical connector as claimed in claim 1, wherein the housing has a mating portion, the shell further contains a dustproof cover, the dustproof cover defines a through cavity for allowing the dustproof cover to slide along the mating portion.

5. The electrical connector as claimed in claim 4, wherein two sides of the dustproof cover respectively protrude outward to form a sliding lump for sliding in a guiding slot respectively defined in the two sidewalls of the shell.

6. The electrical connector as claimed in claim 4, further comprising at least one elastic element, one end of which is against the dustproof cover, and the other end of which passes through the housing and is against the shell.

7. The electrical connector as claimed in claim 6, wherein the elastic element is a spring.
